(19) United States
(12) Patent Application Publication
(10) Pub. No.: US 2007/0232552 A1
(43) Pub. Date: Oct. 4, 2007

(54) Oxophytodienoic acid conjugates as ecological pesticides

(76) Inventors: Mats Ellerstrom, Vastra Frolunda (SE); Mats Andersson, Smalandsstenar (SE); Mats Hamberg, Lidingo (SE)

Correspondence Address: LYNN E BARBER, P O BOX 16528, FORT WORTH, TX, 76162, US

(21) Appl. No.: 11/726,666

(22) Filed: Mar. 22, 2007

Related U.S. Application Data
(60) Provisional application No. 60/786,578, filed on Mar. 28, 2006.

(51) Int. Cl. A01N 43/04

(52) U.S. Cl. 514/25

(57) ABSTRACT

Novel 12-oxophytodienoic acid (OPDA) conjugates named Arabidopside E and G, for improving plant resistance to pathogen attack and/or spread of a pathogen. This is of particular interest in attempts to develop an efficient plant-pesticide and improve the performance of pesticides with regard to efficiency and minimizing negative environmental effects. The same system can be used as a biocide or fungicide in other applications than plant pathogen defense.

### CROSS-REFERENCE TO RELATED APPLICATIONS

This is application claims priority from U.S. provisional patent application Ser. No. 60/786,578 filed Mar. 28, 2006, which is incorporated herein by reference.

### BACKGROUND OF THE INVENTION

1. Field of the Invention

Disclosed herein is an invention in the field of molecular biology, genetics, plant biochemistry and plant biology. More specifically disclosed are two novel 12-oxophytodienoic acid (OPDA) containing galactolipids, named Arabidopside E and Arabidopside G, which are major oxylipins induced during race specific defense in plants.

The invention make use of these two compounds, together or separate, as pesticides for both their antimicrobial effects as well as a way to improve the plant's own defense against pathogens, including reinforcing their immune signaling.

This is a feature of particular interest in attempts to develop an efficient plant-pesticide and improve the performance of pesticides with regard to efficiency and environment. The antimicrobial properties of the two substances can also be used in applications other than plant pathogen defense.

2. Description of the Related Art

It is difficult to accurately quantify the damage or yield loss in agriculture caused by pathogens, but it has been estimated that 36% of the total world crop production is lost to pests and pathogens. In 2002 the economic loss to the world's largest food producer, the United States, is on the order of 33 billion USD annually. This is despite the large-scale use of expensive and environmentally harmful chemicals to control pathogens. In the United States, 700 million USD is spent annually on fungicides alone. Thus, a better understanding of plant defense against pathogens is not only scientifically interesting, but could also have a huge economical and environmental impact.

Plants in the field are challenged by a wide array of potential pathogens, thus the ability to recognize these and launch effective countermeasures is crucial for plant survival. Plants sense the presence of pathogens by many different but intersecting surveillance systems. For example, plants can detect several “general” pathogen-derived molecules or pathogen-associated molecular patterns (PAMPs). The responses following the latter are known as non-race-specific defense. In contrast, race-specific resistance relies on the recognition, by plant-encoded resistance (R) proteins, of specific pathogen-derived effector molecules, known as avirulence (Avr) proteins. Bacterial pathogens deliver Avr proteins into the host cell by type III secretion. The targets of type III effectors, and Avr proteins, likely represent factors in plant cellular metabolism that are “guarded” by the corresponding R proteins. In the absence of R proteins, many type III effector proteins help promote virulence; but in the presence of the corresponding R protein, the Avr protein betrays the pathogen to the plant's surveillance system. The final outcome of successful recognition of an Avr protein by the corresponding R protein is programmed cell death of the infected and adjacent cells. This localized cell death is termed the hypersensitive response (HR). In addition, the cells surrounding the HR form a second line of defense through the activation of defense genes and accumulation of antipathogenic substances. The response as a whole is thought to restrict growth of the pathogen.

The oxidation products of unsaturated fatty acids are collectively known as oxylipins. Oxylipins represent a highly diverse group of substances and have been implicated in a vast array of both developmental processes and responses to stress in plants (Blee (2002) Trends Plant Sci. 7:315; Feussner and Wasternack (2002) Annu. Rev. Plant Biol. 53:275; Howe and Schilmiller (2002) Curr. Opin. Plant Biol. 5:230). These compounds have been shown to function as signalling components during plant pathogen interactions. A number of oxylipins also have direct cytotoxic effects on invading pathogens. Plant oxylipins can be formed enzymatically by lipoxygenases LOX, (Feussner 2002), dioxygenases DOX, (Hamberg et al. (2002), prostaglandins and other Lipid Mediators 68:363), or non enzymatically by chemical oxidation. Plant membrane lipids are rich in di- and trienoic fatty acids that can function as substrates for lipid peroxidation. Particularly well studied examples of plant oxylipins are the jasmonates (Wasternack and Parthier (1997) Trends Plant Sci. 2:302). The jasmonates are formed from the LOX catalysed peroxidation of trienoic fatty acids at the 13-position. The 13-peroxide is modified to an epoxy fatty acid and subsequently cyclized to the compound oxo-phytodienoic acid (OPDA). Jasmonic acid (JA) is synthesized from OPDA by the reduction of a double bound and three rounds of beta oxidation. The pathway can accept C16 as well as C18 fatty acids, in the latter a so called dinor-OPDA is produced (Weber et al. (1997) Proc. Natl. Acad. Sci. USA 94:10473).

The first physiological function found for JA was inhibition of plant growth, (Aldridge, D. C., et al. (1971) J. Chem. Soc. Chem. Com. 1623:1627). From then on, jasmonates were regarded as signaling substances regulating gene expression during biotic and abiotic stress and also as a signal of specific developmental processes during plant development (Creelman and Mullet (1997) Annu. Rev. Plant Phys. Mol. Biol. 48:355; Wasternack and Parthier (1997) Trends in Plant Sci. 2:302). In 1990, it was found that jasmonates are important signaling compounds mediating wound induced signals during attack by herbivores on tomato leaves (Farmer and Ryan (1990) Proc. Natl. Acad. Sci. USA 87:7713). Jasmonates were identified as a trigger for many defense mechanisms in plants induced by pathogens or abiotic stress. Besides the expression of defense genes such as proteinase inhibitors, the synthesis of phytoalexins, alkaloids and insect attractants are the most important responses mediated by jasmonates. These responses are in most cases induced by genetic induction of specific enzymes (Ellard-Ivey and Douglas (1996) Plant Physiol. 112:183; Feussneret al. (1995) Plant J. 7:949). The jasmonate dependent responses were characterized mainly by the study of jasmonate-insensitive and jasmonate synthesis deficient mutants.

Cultivated plants are subjected to attack by many different forms of pathogenic microorganisms such as viruses, bacteria and fungi. In addition, pests such as insects also attack cultivated plants. These attacks weaken the plants and decrease the crop yield. Thus, there is a considerable need to increase the resistance mechanisms of plants and to decrease their sensitivity to pathogens and pests. It is now commonly accepted that the lipoxygenase pathway contributes significantly to plant's defenses against pathogens and pests.

Oxylipin metabolism involves the metabolism of fatty acid hydroperoxide intermediates to different classes of bioactive oxylipins. Four major sub-branches of fatty acid hydroperoxide metabolism have been described, all of which convert 13-hydroperoxy linolenic acid to defense-related compounds. Of these four branches, the most well known is the synthesis of jasmonic acid and related cyclopentanones. However, as yet, knowledge of the metabolic pathways and of the lipoxygenases has not made it possible to develop methods to directly increase plant resistance. To get a better insight into the biological activities of oxylipins, in vitro growth inhibition assays were used to investigate the direct antimicrobial activities of 43 natural oxylipins against a set of 13 plant pathogenic bacteria, oomycetes, and fungi. This study showed that many oxylipins are able to impair growth of at least a subset of the tested plant microbial pathogens (Prost et al. (2005) Plant Physiol. 139:1902).

US Pat. Publication No. 2004/0088752 discloses isolated divinyl ether synthase genes and polypeptides and their use against plant pathogens. The invention of US Pat. Publication No. 2004/0205842 provides transgenic plant cells that have higher levels of lipoxygenase activity than untransformed cells. This is based on studies showing that over-expression of a lipoxygenase in plants directly reduces its sensitivity to pathogens. The present invention specifically uses previously uncharacterised downstream products of the cyclopentanone branch of the lipoxygenase pathway and is thus not related to the inventions in US. Pat. Publication No. 2004/020584 and 2004/0088752.

The applicants of the patent herein have studied the accumulation of oxylipins during the race specific defense. The analysis has revealed that the two major oxylipins induced during race-specific defense are two novel 12-oxophytodienoic acid (OPDA) conjugates, Arabidopside E and Arabidopside G, derived from the chloroplast lipid monogalactosyl diacylglycerol (MGDG). It has been reported that OPDA exists both as a free acid and as conjugate with galactolipids (Stelmach et al. (2001) J. Biol. Chem. 276:12832; Hisamatsu et al. (2003) Tetrahedron Lett. 44:5553; Hisamatsu et al. (2005) J. Nat. Prod. 68:600). It should, however be stressed that OPDA has never before been implicated in race-specific resistance and the two OPDA containing galactolipids that are disclosed are novel yet undescribed compounds.

For a sustainable development of society, it is vital to find new ways to combat plant pathogens. This should be at lower expense for the farmer and lower costs for the consumer, and should minimize the negative environmental effects of pesticide use. Arabidopside E and G, in accordance with the invention, are comparatively harmless compared with substances presently used to combat plant pathogens. Arabidopside E and G are highly biodegradable and thus ecologically safer than most existing pesticides.

This invention should be seen as an alternative and complementary approach to traditional techniques of generating more pathogen resistant crop plants.

### SUMMARY OF THE INVENTION

The present invention provides two novel 12-oxophytodienoic acid (OPDA) conjugates named Arabidopside E and G, for improving plant pathogen resistance.

This is an invention of particular interest in attempts to develop improved and environmentally safe pesticides for use in agriculture. The substances can also be used as a biocide or a fungicide in applications besides plant pathogen defense.

In one aspect this invention relates to a method of controlling pathogens such as Botrytis in plants and seeds, by use of Arabidopside E and G. The substances may be applied directly to the plant. Alternatively, transgenic plants which produce higher levels of Arabidopside E and G could be developed. The invention further provides a method to isolate Arabidopside E and G from plant tissue. Increased endogenous amounts of Arabidopside E and G could also function as a marker in traditional plant breeding.

Other objects and features of the inventions will be more fully apparent from the following disclosure and appended claims.

### BRIEF DESCRIPTION OF THE DRAWINGS

FIG. 1. Quantification of the growth of phytopathogenic bacteria in Arabidopsis thaliana

FIG. 2. Plant recognition of AvrRpm1 causes accumulation of lipid bound OPDA and dinor-OPDA. Leaf tissue from AvrRpm1/Col-0 AvrRpm1/rpm1 or AvrRpm1/act1 was incubated with dexamethasone for 4 hours to induce expression of AvrRpm1 and a total lipid extract was obtained. The lipids were transmethylated with 0.5 M sodium methoxide, the resulting methyl esters were subjected to GC-MS and the amounts of OPDA and dinor-OPDA was quantified.

FIG. 3. Shows the effect of Arabidopside E and G on the growth of Pseudomonas syringae (A and B), Cladosporium cladosporioides (C), Botrytis cinerea (D).

FIG. 4. Reverse phase HPLC chromatogram of OPDA containing lipids. Leaf tissue from AvrRpm1/Col-0 and AvrRpm1/act1 was incubated with dexamethasone, the lipids were extracted and fractionated on a silica column. The glycolipid fraction was separated by TLC and a section of the plate containing OPDA containing lipid was scraped off and subjected to reverse phase HPLC. Solid trace, extract from AvrRpm1/Col; broken trace, extract from AvrRpm1/act1. (Mats kolla gärna en extra gång så detta stämmer)

FIG. 5. Mass spectra of the purified Arabidopsides. Purified Arabidopside E (A and B) and G (C and D) was subjected to negative ion electrospray mass spectrometry and product scan of the molecular ions m/z 1048 (B) or 1076 (C).

FIG. 6. Deduced structures of Arabidopsides E and G. The structures of Arabidopside E and G were elucidated by chemical characterization, mass spectrometry, NMR spectrometry and positional specific hydrolysis. Arabidopside E is an 1-O-(12-oxophytodienoyl)-2-O-(2,3-dinor-12-oxophytodienoyl)-3 -O-(6′-O-(12-oxophytodienoyl)-β-D-galactopyranosyl)-sn-glycerol and Arabidopside G an 1,2-di-O-(12-oxophytodienoyl)-3-O-(6′-O-(12-oxophytodienoyl)-β-D-galactopyranosyl)-sn-glycerol.

### DETAILED DESCRIPTION OF THE INVENTION AND PREFERRED EMBODIMENTS THEREOF

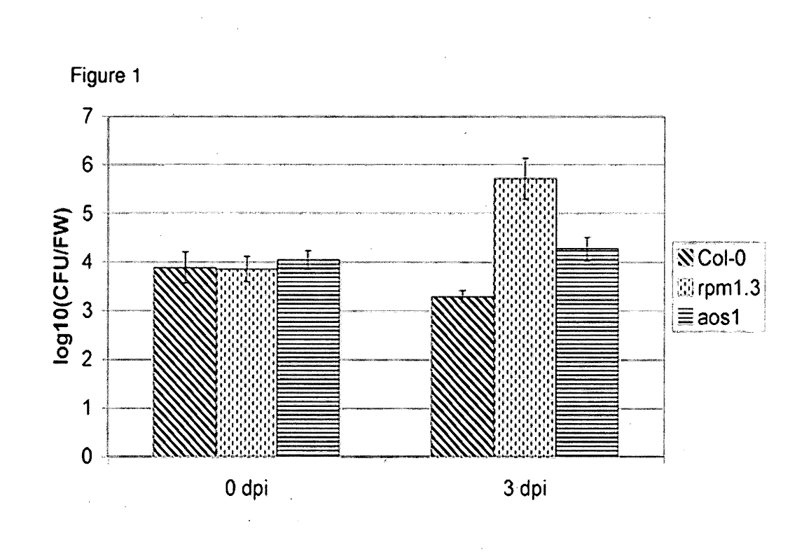

We have demonstrated that two novel substances Arabidopside E and G, accumulate as a consequence of plant specific recognition of the avirulence protein AvrRpm1 from the bacterial pathogen Pseudomonas syringae. The Arabidopsis thaliana ecotype Col-0 has the corresponding resistance gene RPM1 whereas the RPM1 allele rpm1-3 has a stop codon following amino acid 87 (Grant et al., (1995) Science 269:843) and is thus unable to recognize the corresponding Avr protein, AvrRpm1. As both Arabidopside E and G are novel OPDA containing galactolipid derivatives, a first test of function took use of a mutant in the gene allene oxide synthase (aos1). This mutant is unable to synthesize dinor-OPDA and OPDA. The mutant is thus also unable to synthesize Arabidopside E and F. Growth test of P. syringae carrying the avirulence protein AvrRpm1 according to Tornero et al., (2001) on the genetic backgrounds Col-0, rpm1 and oas1 clearly shows that the aos1 mutant is impaired in its defense against the pathogen. The growth of the bacteria in the aos1 mutant was intermediate to that in presence of the resistance gene (Col-0) and the lack thereof (rpm1, FIG. 1). Thus, the lack of OPDA, dinor-OPDA and by that also Arabidopside E and G renders the plant less capable of defending itself against the bacterial pathogen P. syringae.

The sensitivity of different pathogens to a given oxylipin may vary greatly, even among closely related strains (Prost et al. (2005) Plant Physiology 139:1902). This leads to questions concerning the local concentration of oxylipins at infection sites and the likelihood that pathogens come in contact with these compounds. The amount of oxylipins in pathogen-challenged plant tissues has been investigated at the organ level through oxylipin profiling/signature methods. In potato, the amount of individual oxylipins reached up to 200 nmol per gram of inoculated leaf tissue during the first 24 h post infection (Gobel et al. (2002) Biochim. Biophys. Acta 1584:55) and in tobacco leaves, levels up to 500 nmol per gram were observed (Hamberg et al. (2003) J. Biol. Chem. 278:51796). One might expect even higher concentrations at or near infection sites since oxylipins are probably not evenly distributed in inoculated leaves. Additive inhibitory effects might be expected in plants where pathogens have to face various oxylipins produced simultaneously (Prost et al. 2005).

The sensitivity of different pathogens to Arabidopside E and G may vary among different strains. The sensitivity can also vary between crops and climate-conditions.

### Arabidopside E:

### 1-O-(12-oxophytodienoyl)-2-O-(2,3-dinor-12-oxophytodienoyl)-3-O-(6′-O-(12-oxophytodienoyl)-β-D-galactopyranosyl)-sn-glycerol

### Arabidopside G:

### 1,2-di-O-(12-oxophytodienoyl)-3-O-(6′-O-(12-oxophytodienoyl)-β-D-galactopyranosyl)-sn-glycerol

The two novel OPDA galactolipid conjugates (Arabidopside E and G) accumulate to surprisingly high levels (7-8% of total acyl lipid content) during the hypersensitive response. Just the sheer amount of these is a good indication that they may serve an important function in plant defense and not just accumulate as a secondary effect of cellular perturbation. It is also shown that wounding induces the accumulation of Arabidopside E and G.

The sheer amount of Arabidopside E and G formed after AvrRpm1 recognition suggest a function beyond the mere scavenging of OPDA overproduction. In addition, the formation of Arabidopside E and G is a conserved event between at least two different Avr-R gene (AvrRpm1/RPM1 and AvrRpt2/RPS2) interactions. It should also be noted that the levels of Arabidopside E, G and free OPDA after AvrRpm1 recognition is well above the amounts of OPDA needed to inhibit fungal growth and spore germination in vitro (Prost et al., 2005). Thus, it seems likely that Arabidopside E and G functions as an in planta signal as well as an antipathogenic substance. Moreover, antipathogenic substances accumulated during the HR could also have a function beyond stopping the acute infection. The HR results in a (microscopic) “speck” of dead cells that could be a good entry point for necrotrophic pathogens. Thus, a high concentration of antipathogenic substances in the necrotic area could also function as a countermeasure directed against secondary infectious agents.

Therefore this invention makes use of Arabidopside E and F as good novel plant pesticides and in other applications such as fungicides in paint, food or food supplements.

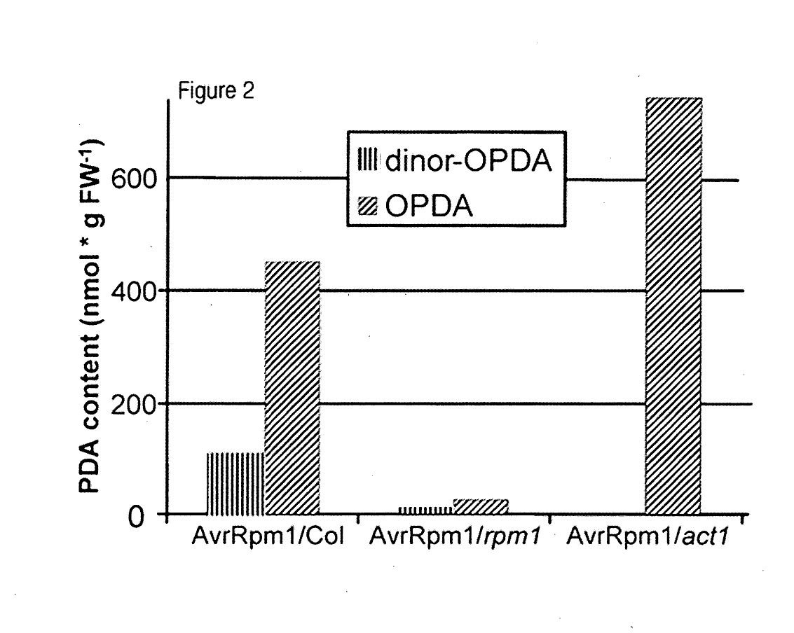

We used a transgenic system to study the effects of plant recognition of the bacterial avirulence protein. A chemical inducible promotor (Aoyama and Chua (1997) Plant J. 11:605) was used to drive the expression of the Pseudoman syringae avirulence protein AvrRpm1 (Mackey et al. (2002) Cell 108:743; Mackey et al. (2003) Cell 112:379). Induction of AvrRpm1 expression led to complete induction of the plant's immune response manifested as cell death throughout the treated tissue. During the response large amounts of the oxylipin 12-oxo-phytodienoic acid (OPDA) and dinor-12-oxo-phytodienoic acid (dinor-OPDA) accumulated in the plant tissue. However, the vast majority of the OPDA and dinor-OPDA was not recovered as a free acid but as a conjugate to a complex lipid. Expression of AvrRpm1 in the rpm1 mutant background, which is unresponsive to AvrRpm1, caused no accumulation of OPDA and dinor-OPDA (FIG. 2). When AvrRpm1 was expressed in the act1 mutant background, which lacks hexadecatrienoic acid, the same amounts of esterified OPDA but no esterified dinor-OPDA accumulated.

An alternative approach to using the Arabidopsides as pesticides is to genetically engineer plants with capacity to synthesize the Arabidopsides “on demand”. The key regulator of the synthetic pathway can be controlled either by inducible expression or expression by native plant disease responsive promoters.

The features of the present invention will be more clearly understood by reference to the following examples, which are not to be construed as limiting the invention.

### EXAMPLE 1

Preparation of Plant Material.

The plant material, for example Arabidopsis thaliana as used in this example, was harvested into a large beaker containing 500 ml 2 mM dexamethasone and 0.005% Silwet L-77. The plant material were incubated on an orbital shaker for the time periods indicated, frozen in liquid nitrogen and stored at −80° C. until further analysis.

### EXAMPLE 2

Quantifying Growth of Phytopathogenic Bacteria in Arabidopsis thaliana.

As Arabidopside E and G are novel OPDA containing galactolipid derivatives, a first test of function took use of an allene oxide synthase deficient Arabidopsis thaliana mutant (aos1). This mutant is unable to synthesize dinor-OPDA and OPDA and thus also Arabidopside E and G. Seedling of Col-0, rpm1 and aos1 were inoculated with P. syringae carrying the avirulence protein AvrRpm1 and the in planta growth of the pathogen was measured as described by Tornero et al. ((2001) Plant J. 28:475, FIG. 1A). The experiment demonstrates that the mutant aos1 is less capable than wild type at controlling the growth of the pathogen. Clearly, the presence of the resistance gene RPM1 is of great importance for the pathogen growth, compare Col-0 (resistance gene) and rpm1 (no resistance). Nevertheless, the lack of the cyclopentanone pathway had a certain effect on the growth of the bacteria. This shows that the lack of OPDA, dinor-OPDA and thus also Arabidopside E and G renders the plant less capable of defending itself against a bacterial pathogen. After a few days the aos1 mutant also developed symptoms not visible in the wild type but reminiscent of the symptoms seen in the non resistant rpm1.3 mutant.

### EXAMPLE 3

In Vitro Antimicrobial Activities of Arabidopside E and F.

For this investigation and screen for activity we have chosen a representative microbial plant pathogen for each of the pathogen genera: bacteria and fungi. Both pathogens are the cause of commercially important plant diseases. The pathogens also represent very different pathogenic strategies rangening from biotrophic to necrotrophic.

| Microbial pathogen | Disease |
|---|---|
| Pseudomonas syringae | Blight, brown spots and bacterial |
| | speck on several species |
| Cladosporium | Blight and pod rot |
| cladosporioides | |
| Botrytis cinerea | Gray mold rot on several crops |

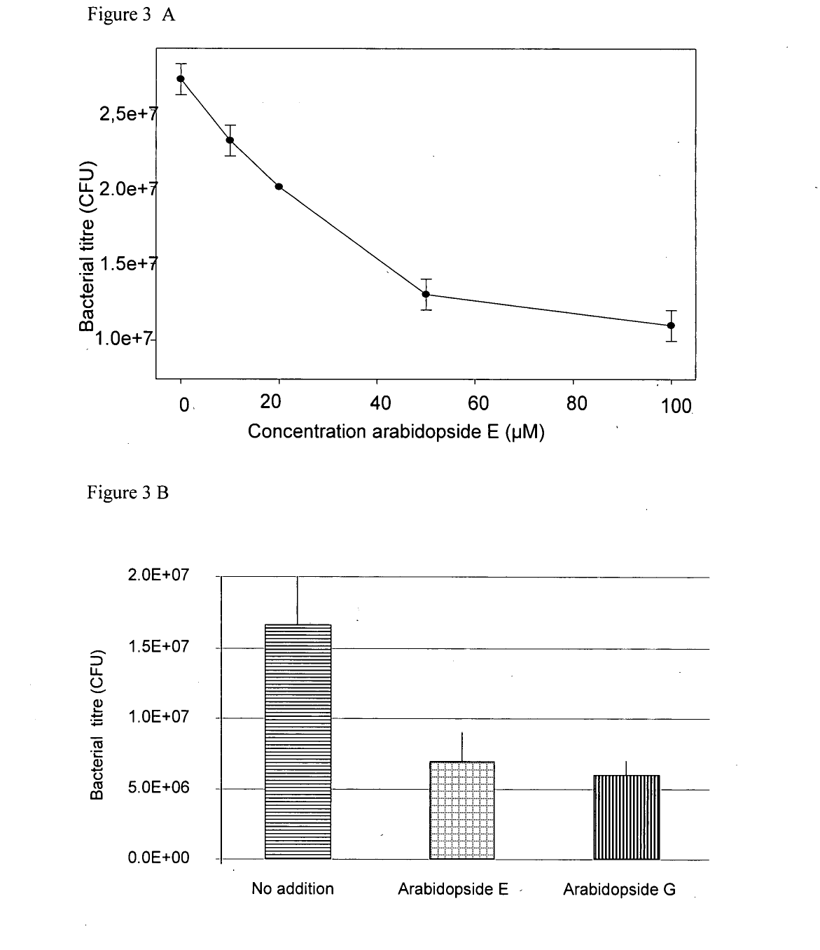

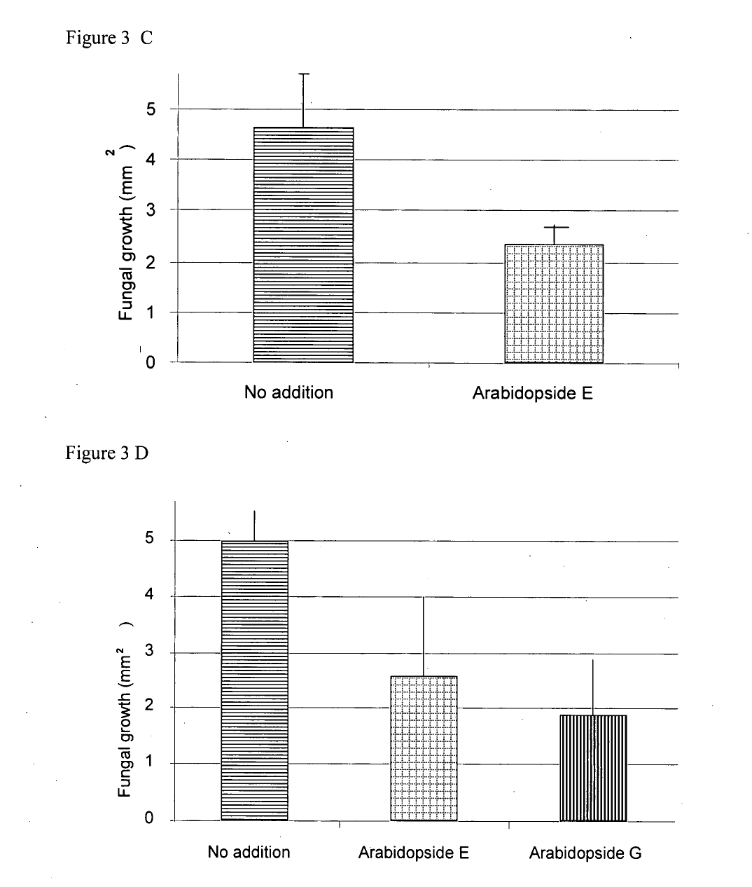

Antipathogenic effects of a 3 to 1 mixture of Arabidopside E and F dissolved in ethanol are tested by addition of the mixture to a nominal concentration of 100 μM to cultures of the indicated pathogens. Each pathogen is tested for growth inhibition in the appropriate medium for 24 hours according to Prost et al. (2005) with minor modifications. Addition of ethanol alone serves as a negative and 2-hexenal as a positive control. Inhibitory effect is expressed as percentage relative to growth of the negative control. The results show that Arabidopside E and G inhibited both bacteria and fungi, FIG. 3.

### EXAMPLE 4

Field Trial Performed in Green House Environment.

Botrytis causes the gray molds or gray mold rots of fruits and vegetables in the field as well as in storage. Almost all fresh fruits, vegetables and bulbs are attacked by Botrytis in storage. Some products, such as strawberry, lettuce, onion, grape and apple are also attacked in the field near maturity or while green. The decay may start at the blossom or steam end of the fruit or at any wound and appears as a well-defined water soaked and subsequently brownish area that penetrates deeply into the tissue and advances rapidly.

Having demonstrated the anti-pathogen efficacy of Arabidopside E and G by laboratory tests, studies are undertaken to demonstrate the function and hardiness of such pesticides under actual field conditions. This field performance ability is demonstrated for Arabidopside E and G on growing plants in their native habitat, under attack by a naturally occurring gray mold.

A hundred tomato plants (cultivar: Ponderosa) are cultivated in polyethylene pots (diameter: 7.5 cm) in a greenhouse of 36 m². The plants are not treated with any pesticide and allowed to be naturally infected with gray mold.

Tomato plants with 10% of the flowers in bloom heavily infected with gray mold are sprayed with 100 μM of a 1 to 3 mixture of Arabidopside E and G, using a back-pack sprayer or as for comparison Euparen M 50 WG (tolyfluanid 520 g/kg) (Kemira OY, Helsinki, Finland) according to the supplier instruction. This concentration is selected on the basis of preliminary experiments. An untreated control is also included in the trial. Treatment is repeated twice, the second 1 week after the first and scored according to a four grade declining scale, with 4 having very good effect on pathogen growth and good quality yield and 1 no effect on pathogen growth and low quality yield. Fertilizers are applied according to conventional farming practice for all treatments.

| | Effect |
|---|---|
| Arabidopside E/F | 3 |
| Euparen | 2 |
| Untreated | 1 |

### EXAMPLE 5

Isolation of the OPDA Containing Compounds

As a first step towards isolating the OPDA containing lipid(s) a lipid extract from AvrRpm1/Col-0 was fractionated on a silica column. The amount of esterified OPDA and dinor-OPDA was measured in three different fractions, neutral lipids eluted with chloroform, sugar containing lipids with acetone and phospholipids with methanol. Approximately 90% of the esterfied OPDA and dinor-OPDA was present in the acetone fraction, indicative of their association with a sugar containing lipid. A number of different galactolipid derivatives containing OPDA and/or dinor-OPDA has been previously reported (Stelmach et al., 2001; Hisamatsu et al. 2003 and 2005). However, the main OPDA containing compound that accumulated in the AvrRpm1 /Col-0 tissue had chromatographic properties inconsistent with any of the previously described compounds. The OPDA containing compound could be purified to homogeneity from a crude lipid extract obtained from a large amount of AvrRpm1/Col tissue. The crude extract was fractionated on a silica column. The glycolipid containing acetone fraction was separated by preparative TLC using the solvent system etylacetate:acetic acid (70:0.5, v/v). A broad zone (Rf=0.3-0.45) that yielded OPDA methyl esters after transmethylation was scraped off and the compound eluted from the silica with methanol. The compound was further purified by reverse phase HPLC using a Nucleosil 100-5 C18 column (250×4.6 mm) and a solvent system of acetonitrile-water 85:15 (v/v, FIG. 3). The material obtained from the preparative TLC of extract from AvrRpm1 /Col yielded one major peak (RT 9-10 min) and a minor peak (RT 14-15 min) that was collected and dried. Both fractions yielded OPDA after hydrolysis, but only the major peak contained any dinor-OPDA. The intensity ratio between the OPDA derivatives and dinor-OPDA derivatives in the major peak was close to 2:1. The experiment, coupled with the molecular mass determination (vide infra), thus demonstrated the presence of 2 OPDA residues and 1 dinor-OPDA residue in the purified lipid in one of the purified lipids. When lipid extract obtained from AvrRpm1/act1 was used for the purification only the second peak (RT 14-15 min) was the major peak and the slower migrating was reduced to less than 1/10 of the amount in AvrRpm1/Col-0 extract.

### EXAMPLE 6

Purification of Arabidopside E and G

A total lipid extract was obtained from induced leaf tissue after 4 hours of incubation in dexamethasone. The plant material was ground in chilled methanol and the methanol evaporated under reduced pressure. The residue was partitioned against ethyl acetate. The ethyl acetate phase was dried and the residue dissolved in chloroform. The chloroform solution was loaded onto a silica column. Neutral lipids were eluted with chloroform and glycolipids with acetone. The acetone eluate was separated by preparative thin layer chromatography with plates precoated with Silica Gel G and a solvent system of ethyl acetate-acetic acid (70:0.5, v/v). Zones were visualized by spraying with 2′,7′-dichlorofluorescein and viewing under UV light. The zone corresponding to Arabidopside E was scraped off and eluted with methanol. The compound was further purified by reverse phase HPLC which was carried out with a Bischoff model 2250 compact pump (Bischoff Analysentechnik, Leonberg, Germany). A Nucleosil 100-5 C18 column (250×4.6 mm, Macherey-Nagel Düren, Germany) and a solvent system of acetonitrile-water 85:15 (v/v) were used (FIG. 3).

### EXAMPLE 7

Mass Spectrometry of Arabidopside E and G

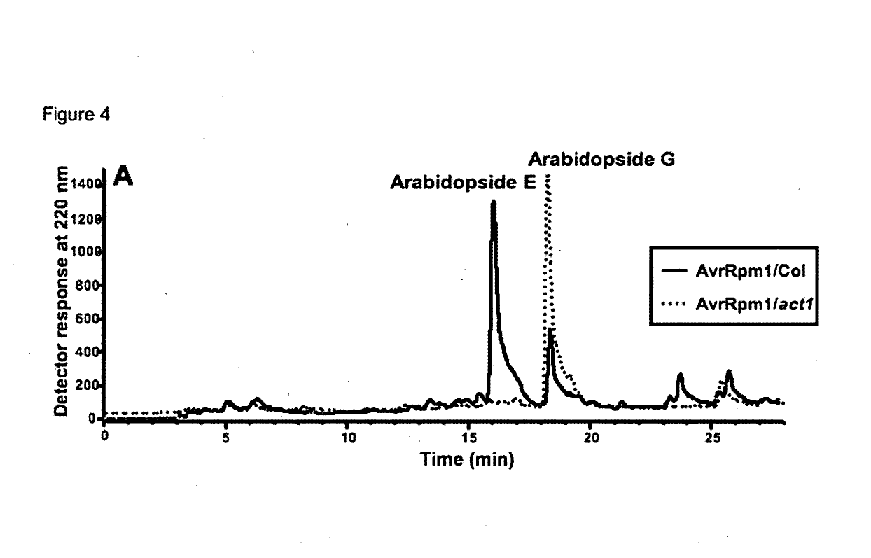

A mass spectrum (FIG. 4A) of the compound containing both OPDA and dinor-OPDA recorded in the negative mode revealed an [M−H]− ion at m/z 1047 indicating a molecular mass of 1048 D. The MS/MS spectrum of m/z 1047 (FIG. 4B) showed ions at m/z 801 (loss of 247 by cleavage at C-1/C-2 of one of the OPDA residues), 773 (loss of 275 by acyl-oxy cleavage of one to the OPDA residues), 291 (OPDA-H), and 263 (dinor-OPDA-H). The mass spectrum recorded in the positive ion mode showed an [M+H]+ ion at m/z 1049 (not shown). The MS/MS spectrum of m/z 1049 showed only weak signals, presumably due to the lack of easily protonated groups in the molecule. The mass spectral results combined with the chemical data are consistent with that the compound was a monogalactosyl diglyceride containing two OPDA acyl chains and one dinor OPDA acyl chain.

A mass spectrum of the compound containing only OPDA recorded in the negative mode revealed an [M−H]− ion at m/z 1075 indicating a molecular mass of 1076 D. The MS/MS spectrum of m/z 1075 showed ions consistent with a monogalactosyl diglyceride containing three OPDA acyl chains.

By analogy with the previously reported series of OPDA containing galactolipids, we provisionally name the two compounds Arabidopside E (two OPDA and one dinor-OPDA residue) and G (three OPDA residues).

### EXAMPLE 8

NMR Spectra of Arabidopside E

To determine the exact stereochemistry of Arabidopside E, NMR spectra was recorded. Several structural elements of the purified compound were assigned or confirmed from NMR data analysis. First, based on the downfield chemical shifts for the protons associated with the glycerol C-1 (δ 4.48, 4.26) and C-2 (δ 5.30) positions, it was clear that ester groups were attached at these to two locations. The 1H NMR chemical shifts of H2-3 (δ 3.94, 3.81) of the glycerol chain indicated substitution at C-3 with a sugar residue. The galactose identity of this sugar was easily deduced by coupling constant and NOE analysis of the various methine protons about the pyran ring (Table I). That C-6′ was substituted with an acyl group was readily apparent from the downfield chemical shift of the methylene protons (δ 4.36, 4.25). Furthermore, HMBC correlations between these C-6′ methylene protons and a carbonyl at δ 175.4 further confirmed this assignment.

All three of the acyl groups were deduced to possess cis ring junctures by virtue of a strong NOE enhancement of the 3 proton multiplet at d 2.53 (H-11″/13″′/13″″) following irradiation of isochronous protons H-7″, H-9″′ and H-9″″(δ 3.09). The chemical shifts of the olefinic protons at the ω-3 and ω-4 positions were isochronous such that the geometry could not be deduced by straightforward coupling constant analysis. However, the geometry of the ω-3 double bonds in all three acyl groups was clearly revealed from strong NOE correlations between the olefinic protons, and the chemical shift of the ω-2 carbon at d 21.9 (for trans ω-3 olefins ω-2 13C NMR shift would be δ 30-33 (Pfeffer et al. (1977) J. Am. Oil Chem. Soc. Trans. 54:380; Pfeffer et al. (1992) Lipids 27:258).

In summary, the NMR spectral data supported the notion that the purified compound corresponded to a monogalactosyl diglyceride containing OPDA and dinor-OPDA. One of the acyl chains was clearly esterified to the galactose moiety. However, the positional specificity the C16 and C18 OPDA could not be determined. Lipase from Rhizopus arrhizus hydrolyzes the sn-1 ester bond and the galactose C-6′ ester bond of galactolipids acylated at this position, but not the sn-2 ester bond of galactolipids (Fischer et al. (1973) Hoppe Seylers Z. Physiol. Chem. 354:1115). Treatment of the purified lipid with R. arrhizus lipase released OPDA but no detectable amounts of dinor-OPDA. Thus, the two OPDA residues were esterified to the sn-1 and the galactosyl-6′ positions, whereas the dinor-OPDA residue was esterified to the sn-2 position.

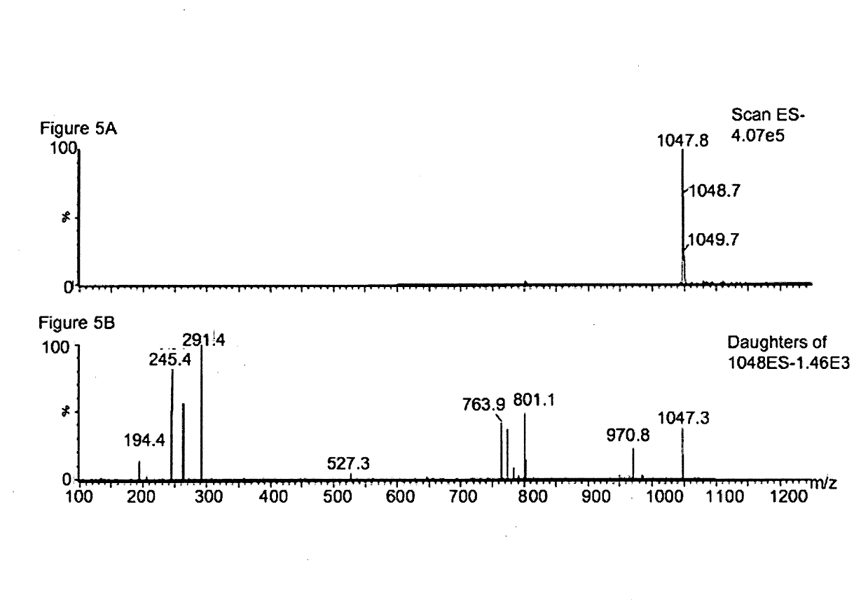

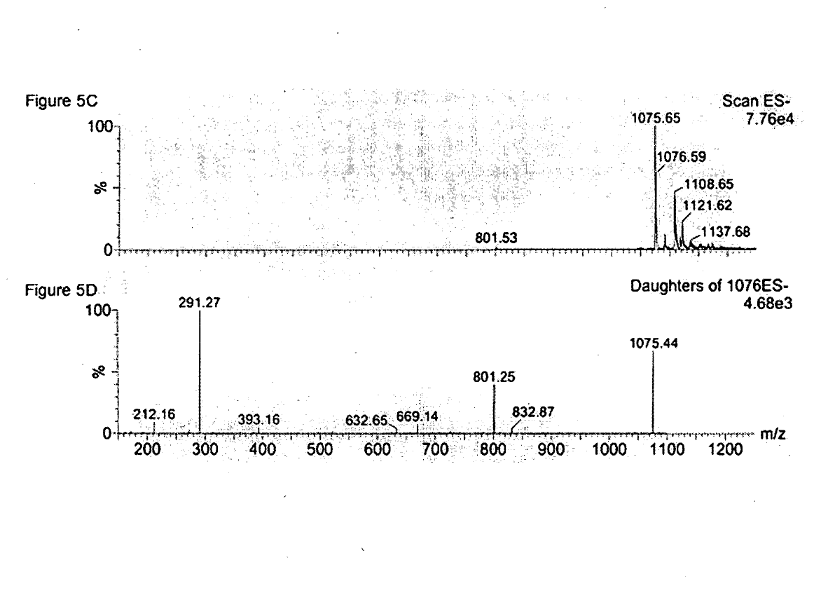

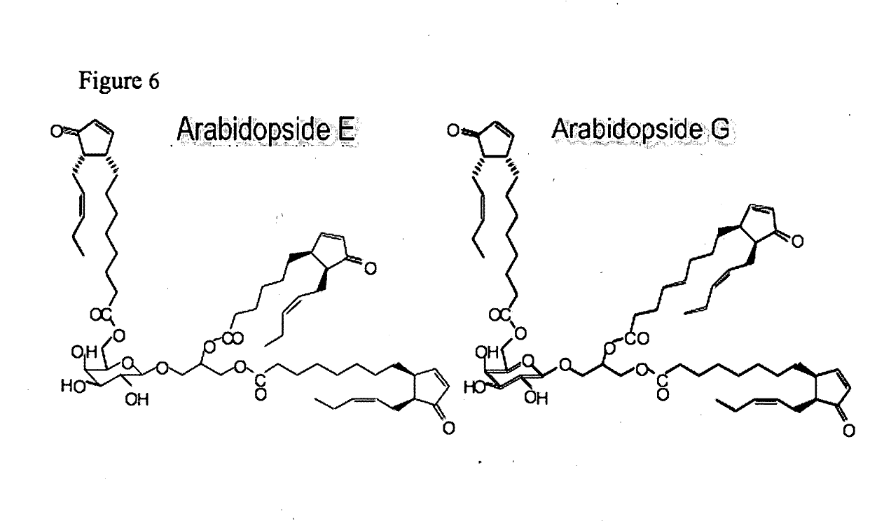

The deducted structures of Arabidopsides E and G elucidated by the different methods described herein are shown in FIG. 5.

Table I shows the selected NMR Data for compound X₁ in CD₃OD (300 MHz, solvent used as an internal reference and calibrated to δ_{H} 4.87, δ_{C} 49.15)

TABLE I

| Atom | δ_{C} ppm | δ_{H} ppm(mult, | | |
|---|---|---|---|---|
| number | mult. | J/Hz) | HMBC | NOE |
| 1a | 64.0 CH₂ | 4.48(dd, 12.1, 3.2) | C-1″′ | |
| B | | 4.26(m) | C-1″′, C-2 | |
| 2 | 72.0 CH | 5.30(m) | — | |
| 3a | 69.1 CH₂ | 3.94(dd, 11.1, 5.5) | C-2, C-1 | |
| B | | 3.81(m) | C-2, C-1 | |
| 1′ | 105.6 CH | 4.27(d, 7.2) | C-3 | H-3′, H-5′ |
| 2′ | 72.3 CH | 3.54(dd, 9.8, 7.2) | C-3′ | |
| 3′ | 74.8 CH | 3.51(dd, 9.8, 3.2) | C-2′ | H-1′, H-4′, H-5′ |
| 4′ | 70.4 CH | 3.83(m) | C-2′, C-3′, C-6′ | H-3′, H-5′ |
| 5′ | 74.3 CH | 3.76(m) | C-4′, C-6′ | H-1′, H-3′, H-4′ |
| 6′a | 64.9 CH₂ | 4.36(dd, 11.4, 7.7) | C-5′, C-1” | H-5′ |
| b | | 4.25(m) | | |
| 1” | 175.4 C | — | — | |
| 2” | 35.14 CH₂ | 2.38(m) | C-1”, C-3”, C-4” | |
| 3” | 26.0 CH₂ | 1.66(m) | C-1” | |
| 4” | *30.46 CH₂ | 1.38(m) | | |
| 5” | 28.5 CH₂ | 1.52(m) | | |
| 6”a | 31.9 CH₂ | 1.80(m) | — | |
| b | | 1.23(m) | | |
| 7” | 45.9 CH | 3.09(m) | — | H₂-6”, H-8”, H-11” |
| 8” | 170.1 CH | 7.95(dd, 5.9, 2.6) | C-7”, C-9”, C-10”, C-11” | |
| 9” | 133.1 CH | 6.20(dm, 5.9) | C-7”, C-8”, C-10”, C-11” | |
| 10” | 213.64 C | — | — | |
| 11” | 51.1 CH | 2.53(m) | C-7”, C-8”, C-10”, C- | H-7” |
| | | | 12”, C-13” | |
| 12”a | 25.1 CH₂ | 2.46(m) | C-10”, C-13”, C-14” | |
| b | | 2.21(m) | | |
| 13” | 128.40 CH | 5.43(m) | C-12” | |
| 14” | 134.0 CH | 5.45(m) | C-12”, C-15”, C-16” | |
| 15” | 21.9 CH₂ | 2.11(m) | C-13”, C-14”, C-16” | |
| 16” | 14.6 CH₃ | 1.02(t, 7.6) | C-14”, C-15” | |
| 1″′, 1″″ | 174.6, 175.1 C | | — | |
| 2″′, 2″″ | 35.08 CH₂ | 2.38(m) | C-1″′/1″″, C-3″′/3″″, | |
| | | | C-4″′/4″″ | |
| 3″′, 3″″ | 26.2 CH₂ | 1.66(m) | C-1″′/1″″, C-2″′/2″″, | |
| | | | C-4″′/4″″, C-5″′/5″″ | |
| 4″′, 4″″ | *30.40 CH₂ | 1.38(m) | C-2″′/2″″, C-5″′/5″″, | |
| | | | C-6″′/6″″ | |
| 5″′, 5″″ | 28.8 CH₂ | 1.46(m) | C-6″′/6″″ | |
| 6″′, 6″″ | *30.9 CH₂ | 1.38(m) | C-5″′/5″″, C-7″′/7″″ | |
| 7″′, 7″″ | *30.25 CH₂ | 1.38(m) | C-6″′/6″″ | |
| | *30.30 CH₂ | 1.38(m) | C-6″′/6″″ | |
| 8″′, 8″″a | 32.0 CH₂ | 1.80(m) | — | |
| b | | 1.23(m) | | |
| 9″′, 9″″ | 46.0 CH | 3.09(m) | — | H₂-8″′/8″″, H- |
| | | | | 10″′, 10″″, |
| | | | | H-13″′/13″″ |
| 10″′, 10″″ | 170.3 CH | 7.95(dd, 5.9, 2.6) | C-9″′/9″″, C-11″′/11″″, | |
| | | | C-12″′/12″″, C-13″′/13″″ | |
| 11″′, 11″″ | 133.0 CH | 6.20(dm, 5.9) | C-9″′/9″″, C-10″′/10″″, | |
| | | | C-12″′/12″″, C-13″′/13″″ | |
| 12″′, 12″″ | 213.53 C | — | — | |
| 13″′, 13″″ | 51.1 CH | 2.53(m) | C-9″′/9″″, C-10″′/10″″, | H-9″′/9″″ |
| | | | C-12″′/12″″, C- | |
| | | | 14″′/14″″, C-15″′/15″″ | |
| 14″′, 14″″a | 25.1 CH₂ | 2.46(m) | C-12″′/12″″, C- | |
| b | | 2.21(m) | 15″′/15″″, C-16″′/16″″ | |
| 15″′, 15″″ | 128.45 CH | 5.43(m) | C-14″′/14″″ | |
| 16″′, 16″″ | 133.9 CH | 5.45(m) | C-14″′/14″″, C- | |
| | | | 17″′/17″″, C-18″′/18″″ | |
| 17″′, 17″″ | 21.9 CH₂ | 2.11(m) | C-15″′/15″″, C- | |
| | | | 16″′/16″″, C-18″′/18″″ | |
| 18″′, 18″″ | 14.6 CH₃ | 1.02(t, 7.6) | C-16″′/16″″, C-17″′/17″″ | |

### EXAMPLE 9

Biodegradability Test

Biodegradability was tested by addition of a mixed microbial culture taken from a sewer treatment plant to a solution of 100 μM radiolabelled (¹⁴C) Arabidopside E and G in a 3 to 1 ratio in a rich culture media. Degradation was determined by quantifying the amounts of the Arabidopside associated radiolabel and the total turn over was estimated by determining percentage radioactivity as CO₂ released to the gaseous phase at different time points. Degradation of Arabidopsides was determined to occur in 1 to 2 hours and total turnover was estimated to occur in 6 to 12 hours.

1. A pesticide comprising a 12-oxophytodienoic acid conjugate selected from the group consisting of: 1-O-(12-oxophytodienoyl)-2-O-(2,3-dinor-12-oxophytodienoyl)-3 -O-(6′-O-(12-oxophytodienoyl)-β-D-galactopyranosyl)-sn-glycerol and 1,2-di-O-(12-oxophytodienoyl)-3-O-(6′-O-(12-oxophytodienoyl)-β-D-galactopyranosyl)-sn-glycerol.

2. The pesticide of claim 1, wherein the 12-oxophytodienoic acid conjugate is 1-O-(12-oxophytodienoyl)-2-O-(2,3-dinor-12-oxophytodienoyl)-3-O-(6′-O-(12-oxophytodienoyl)-β-D-galactopyranosyl)-sn-glycerol.

3. The pesticide of claim 1, wherein the 12-oxophytodienoic acid conjugate is 1,2-di-O-(12-oxophytodienoyl)-3-O-(6′-O-(12-oxophytodienoyl)-β-D-galactopyranosyl)-sn-glycerol.

4. The pesticide of claim 1, further comprising a suitable carrier or diluent.

5. The pesticide of claim 1, wherein the pesticide is active against plant pathogens.

6. The pesticide of claim 5, wherein the plant pathogens are selected from the group consisting of bacteria, viruses, oomycetes and fungi.

7. The pesticide of claim 1, wherein the plant pathogen is Botrytis.

8. A method of treatment for combating a plant pathogen comprising applying to plants an effective dose of the pesticide of claim 1.

9. The method of claim 8, wherein the pesticide is applied directly to plants.

10. The method of claim 9, wherein the pesticide is sprayed on the plants.

11. The method of claim 8, wherein the plants are selected from the group consisting of: Triticum aestivum, Oryza sativa, Zea maus, Hordeum vulgare, Solanum tuberosum, Glycine max, Phafeolus spp, Theobroma cacao, Manihot esculenta, Ipomoea and Gossypium.

12. The method of claim 8, wherein a dose of between 20 and 100 μM is applied to the plants.

13. The method of claim 8, wherein the concentration of the pesticide is 30 μM.

14. The method of claim 8, wherein the pathogen is selected from the group consisting of bacteria, viruses and fungi.

15. The method of claim 14, wherein the plant pathogen is Botrytis.

16. A method for the control of harmful plant pathogens, comprising treating the plant pathogens, plants, ground or seeds to be protected from the plant pathogens with an effective amount of the pesticide of claim 1
